(19) United States
(12) Patent Application Publication
(10) Pub. No.: US 2025/0289181 A1
(43) Pub. Date: Sep. 18, 2025

(54) MULTI-MATERIAL PRINTING RESERVOIR AND PLATFORM SYSTEM FOR ADDITIVE MANUFACTURING DEVICES

(71) Applicant: SprintRay, Inc., Los Angeles, CA (US)

(72) Inventors: Shukun Ye, Los Angeles, CA (US); Steven Shao, Los Angeles, CA (US); Amir Mansouri, Los Angeles, CA (US); Huijian Tian, Los Angeles, CA (US)

(21) Appl. No.: 19/059,144

(22) Filed: Feb. 20, 2025

Related U.S. Application Data
(63) Continuation-in-part of application No. 18/244,380, filed on Sep. 11, 2023.
Application No. 18/244,380 is a continuation of application No. 18/133,521, filed on Apr. 11, 2023, now abandoned.
(60) Provisional application No. 63/329,847, filed on Apr. 11, 2022.

(51) Int. Cl. B29C 64/245; B29C 64/255; B29C 64/295

(52) U.S. Cl. CPC B29C 64/245; B29C 64/255; B29C 64/295

(57) ABSTRACT

The invention is a 3D printing system for retrofitting a 3D printer to print multiple 3D-printed objects. The system includes a platform adapted to be used with the 3D printer, which includes a plurality of build surfaces, multiple reservoirs adapted to register with the build surfaces of the platform, each reservoir storing a unique printing material, and an adapter configured to secure the reservoirs to a base of the 3D printer in a manner so that: each of the reservoirs are aligned with a curing light engine of the 3D printer, and each of the reservoirs registers with a corresponding build surface of the build surfaces of the platform. This system enables simultaneous printing with multiple photopolymer materials, significantly reducing overall printing time and improving printing efficiency.

### PRIORITY OR RELATED APPLICATIONS

This application is a continuation-in-part of U.S. Non-Provisional application Ser. No. 18/244,380, filed on Sep. 11, 2023, which is a continuation of U.S. patent application Ser. No. 18/133,521, filed on Apr. 11, 2023, which is a Non-provisional application of, and claims priority to, U.S. Provisional Application No. 63/329,847, filed on Apr. 11, 2022, the disclosure of each incorporated by reference in their entirety.

### TECHNICAL FIELD

The present invention generally relates to additive manufacturing devices. More specifically, the present invention relates to devices, systems, and methods for creating three-dimensional (3D) objects with additive manufacturing techniques that employ a single-use cartridge, which may be disposable or recyclable.

### BACKGROUND

3D printing is a process that creates three-dimensional objects by depositing materials, usually in layers. Additive manufacturing uses 3D modeling software to create designs or scan objects. The software then translates the design into a layer-by-layer framework for additive manufacturing. 3D printing encompasses several manufacturing technologies. Each technology differs in material selection, surface finish, durability, and manufacturing speed and cost. One among them is Digital Light Processing (DLP).

DLP is a process of creating objects by a 3D printer that uses a digital light projector as the light source for curing photo-reactive polymers. The DLP technology utilizes light and a liquid resin to make solid parts and products. The light source incident on the surface of the object being printed is controlled by micromirrors present in the system. In general, the DLP printers are built around a resin tank with a transparent bottom and a build platform at the top to create objects layer by layer. It is similar to Stereolithography (SLA) but differs in the use of the different light sources.

A process of additive manufacturing using Stereolithography has four essential components. It uses a Photopolymer, housed in a VAT, which is exposed to a Light source. The light from the light source initiates polymerization to convert liquid to solid on a build platform, to which the solid part attaches to. Current systems utilize a generalized VAT, which houses a high volume of photopolymer and uses large platforms to provide a high degree of versatility to print. This has a drawback in the form that more resin is needed to initiate prints and if a print fails, it brings a risk of wasting more volume of resin. Furthermore, the resin is poured at the discretion of the user who can either pour a high or low volume of resin which might cause a failed print.

Various additive manufacturing processes and technologies are known in the art, however, none of them provide solution as an additive manufacturing device with multiple tanks on the same printer (i.e., DLP printer) with single Z-axis control for printing multiple materials at once. Further, a disposable or reusable cartridge to build specific components with minimal resin handling is nowhere disclosed.

Therefore, there is a need for a 3D printing device to print multiple materials at once. Also, there is a need for a device with a disposable or single-use cartridge that minimizes waste and obviates the need for some equipment. Further, there is a need for a cartridge, container, or tank assembly that minimizes the forming material waste during small batch printing. It is to these ends that the present invention has been developed.

### SUMMARY OF THE INVENTION

The present invention generally discloses an additive manufacturing device that employs a single-use cartridge or reservoir assembly adapted to minimize forming material waste during small batch printing.

In exemplary embodiments, the cartridge, which may be disposable or recyclable, includes a built-in forming material reservoir and build plate that is utilized by an additive manufacturing device to form a single 3D object.

According to some aspects of the invention, a 3D printing system for retrofitting a 3D printer to print multiple 3D-printed objects is provided. The system includes a platform adapted to be used with the 3D printer, which includes a plurality of build surfaces, multiple reservoirs adapted to register with the build surfaces of the platform, each reservoir storing a unique printing material, and an adapter configured to secure the reservoirs to a base of the 3D printer in a manner so that: each of the reservoirs are aligned with a curing light engine of the 3D printer, and each of the reservoirs registers with a corresponding build surface of the build surfaces of the platform. This system enables simultaneous printing with multiple photopolymer materials, significantly reducing overall printing time and improving printing efficiency.

According to some aspects of the present invention, the additive manufacturing device may be referred to as a 3D printer. The 3D printer may comprise a container or cartridge-based resin tank that may be pre-filled and sealed with a forming material such as a light-curable resin. In some exemplary embodiments, the cartridge-based resin tank with light-cured resin is an innovative and intelligent solution that has been designed to allow operators to go through the print process with minimal resin handling and eliminates the need to measure the amount of resin during setup. In some exemplary embodiments, the resin is in a form of liquid or paste. The resin is hardened using visible and/or ultraviolet (UV) light. In some exemplary embodiments, the cartridge-based resin tank comprises a penetrable layer or sealing layer on its top side. The penetrable layer is configured to seal the resin. In some exemplary embodiments, the cartridge-based resin tank further comprises an optically clear layer on another side. The optically clear layer is configured to allow the passage of UV light to initiate polymerization.

In some exemplary embodiments, the cartridge-based resin tank comprises a small build platform area or build platform or build plate. In some exemplary embodiments, the build platform is a surface to which the printed part adheres during the printing process. In some exemplary embodiments, the build platform is configured to support the printed part during the printing process. In some exemplary embodiments, the build platform allows for application-specific containers to minimize resin waste during small print batches. In some exemplary embodiments, the container and build platform may come in a type of cartridge that is used up to build specific components, for example, a dental appliance. Once built, the cartridge-based resin tank and build platform or cartridge is used up and thrown out, that is disposable, or recycled.

In some exemplary embodiments, the cartridge-based resin tank further comprises a print screen or print surface. In some exemplary embodiments, the print screen is the surface that allows light to pass through to cure the resin. The print screen is bonded with the cured resin. The bond between the print screen and resin is weak enough that the part can be separated from the print screen in order to print the next layer. In some exemplary embodiments, the print occurs inside the cartridge-based resin tank that is pre-filled with the resin. In some exemplary embodiments, the build platform and print screen are incorporated into the sealed, prefilled cartridge-based resin tank of light cured resin.

In some exemplary embodiments, the build platform may be located internal or external to the cartridge-based resin tank. In some exemplary embodiments, the build platform is incorporated into the cartridge-based resin tank. In this arrangement, the cartridge-based resin tank houses the resin and the build platform. In some exemplary embodiments, a Z axis arm of the 3D printer houses a mating arrangement. The mating arrangement is configured to mate with the build platform in the cartridge-based resin tank and breaks the seal for the resin in the cartridge-based resin tank. Once the print is finished, the printed part is removed from the print screen and the build platform can be discarded. In this type of build platform configuration, the platform arm and the external printer features get very little resin exposure and do not require user cleaning.

In another embodiment, the build platform resides external to the cartridge-based resin tank. In some exemplary embodiments, the build platform may be located on the Z axis arm of the 3D printer. In this arrangement, the build platform resides on the Z axis arm. In some exemplary embodiments, the build platform has an arrangement that allows it to puncture the seal on the top side of the cartridge-based resin tank and access the resin to initiate the printing process.

In some exemplary embodiments, the build platform interacts with the penetrable layer or sealing surface in different methods to access the resin. The interaction methods may include a puncture interaction method and a built-in platform interaction method. In puncture interaction method, the sealing surface of the cartridge-based resin tank is punctured by the build platform. In some exemplary embodiments, the puncture is designed to eliminate the contamination of the resin from the seal.

In built-in platform interaction method, the build platform resides inside of the cartridge-based resin tank. In some exemplary embodiments, a mechanism associated with the Z axis arm interacts with the build platform and clutches the build platform to initiate the printing process. In some exemplary embodiments, the build platform punctures the penetrable layer before initiating the printing process. In another embodiment, the penetrable layer moves and flexes according to the printing cycle. In some exemplary embodiments, the penetrable layer is made of a flexible material.

In some exemplary embodiments, the cartridge-based resin tank is used with one or more adapters to house the resin vat. The adapter may interact with the cartridge-based resin tank through either a mechanical fastening or a magnetic fastening. In some exemplary embodiments, the adapter may be a fixed part or a removable part.

In another embodiment, a single DLP printer is used to print with multiple materials at once. The single DLP printer comprises a platform that can be split but not have independent z-axis controls. In some exemplary embodiments, the single DLP printer comprises a container. In some exemplary embodiments, the container may be a disposable tank that holds the print resin during the printing process. In some exemplary embodiments, the container is pre-filled with light-cured resin for the printing process. In some exemplary embodiments, the container comprises one or more compartments configured to hold the print resin during the printing process. The container physically separates the resin into separate compartments. This can be done with a divider on a single part of the use of multiple containers.

In some exemplary embodiments, the container further comprises a build platform or build plate. In some exemplary embodiments, the build platform is the surface that the printed part adheres during the printing process. In some exemplary embodiments, the container and the build platform may come in a type of cartridge that is used up to build specific components, for example, a dental appliance. In some exemplary embodiments, the container further comprises a print screen. In some exemplary embodiments, the print screen is the surface that allows light to pass through to cure the resin. The print screen is bonded with the cured resin. The bond is weak enough that the part can be separated from the screen in order to print the next layer. In some exemplary embodiments, the build platform further comprises at least one built-in heater to achieve a faster heat up time.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates a block diagram for a system in accordance with some exemplary embodiments of the present invention

FIG. 1A illustrates a cut-sectional view of a cartridge in accordance with some exemplary embodiments of the present invention.

FIG. 1B illustrates the operation of a cartridge in accordance with some exemplary embodiments of the present invention.

FIG. 2 illustrates a system in accordance with some exemplary embodiments of the present invention.

FIG. 3-FIG. 5 illustrate an adapter and adapter components for utilizing a cartridge in accordance with the present invention with conventional 3D printers

FIG. 6 illustrates an exploded view of a cartridge in accordance with some exemplary embodiments of the present invention in which multiple

FIG. 7 illustrates a perspective view of a resin tank in accordance with some exemplary embodiments of the present invention.

FIG. 8-FIG. 9 illustrate different perspective views of a build platform of the 3D printer in some exemplary embodiments of the present invention.

FIG. 10 illustrates an exploded view of a cartridge in accordance with some exemplary embodiments of the present invention.

FIG. 11 illustrates a perspective view of a cartridge in accordance with the embodiment illustrated in FIG. 10.

FIG. 12-FIG. 17 illustrates different perspective views of adapters in accordance with some exemplary embodiments of the present invention.

FIG. 18 illustrates a block diagram of a device or kit in accordance with some exemplary embodiments of the present invention.

FIG. 18-1 illustrates a block diagram of a system in accordance with some exemplary embodiments of the present invention.

FIG. 18-2 illustrates a flow chart of a method in accordance with some exemplary embodiments of the present invention.

FIG. 19 illustrates an exploded view of a 3D printing kit in accordance with the present invention.

FIG. 20 illustrates a posterior bottom perspective view of a platform of a 3D printing kit in accordance with the present invention.

FIG. 21 illustrates an isometric side view of a platform of a 3D printing kit in accordance with the present invention, further illustrating a detailed view of the interior of the multiple build platforms.

FIG. 22 illustrates an isometric side view of the plurality of tanks of a 3D printing kit in accordance with the present invention.

FIG. 23 illustrates an exploded view of one of the plurality of resin tanks of 3D printing kit in accordance with the present invention.

FIG. 24 illustrates a rear view of a resin tank of a 3D printing kit in accordance with the present invention.

FIG. 25 illustrates a top view of the plurality of resin tanks of a 3D printing kit in a stacked state.

FIG. 26 illustrates a cross-sectional view at A-A in FIG. 24.

FIG. 27 illustrates a cross-sectional view of the plurality of resin tanks of a 3D printing kit in a stacked state.

FIG. 27-1 illustrates reservoirs coupled to an adapter in accordance with the present invention.

FIG. 28 illustrates an isometric side view of the adapter of a 3D printing kit in accordance with the present invention.

FIG. 29 illustrates a top view of an adapter of a 3D printing kit in accordance with the present invention.

FIG. 30 illustrates a cross-sectional view at A-A in FIG. 28.

FIG. 31A-FIG. 31B illustrates a posterior bottom perspective view of an adapter of a 3D printing kit in accordance with the present invention.

FIG. 32 illustrates a cross-sectional view at B-B in FIG. 28.

FIG. 33 illustrates an exemplary flow chart for an RFID reading of an adapter of a 3D printing kit in accordance with the present invention.

### DETAILED DESCRIPTION OF THE INVENTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. Generally, the invention involves an apparatus and system for

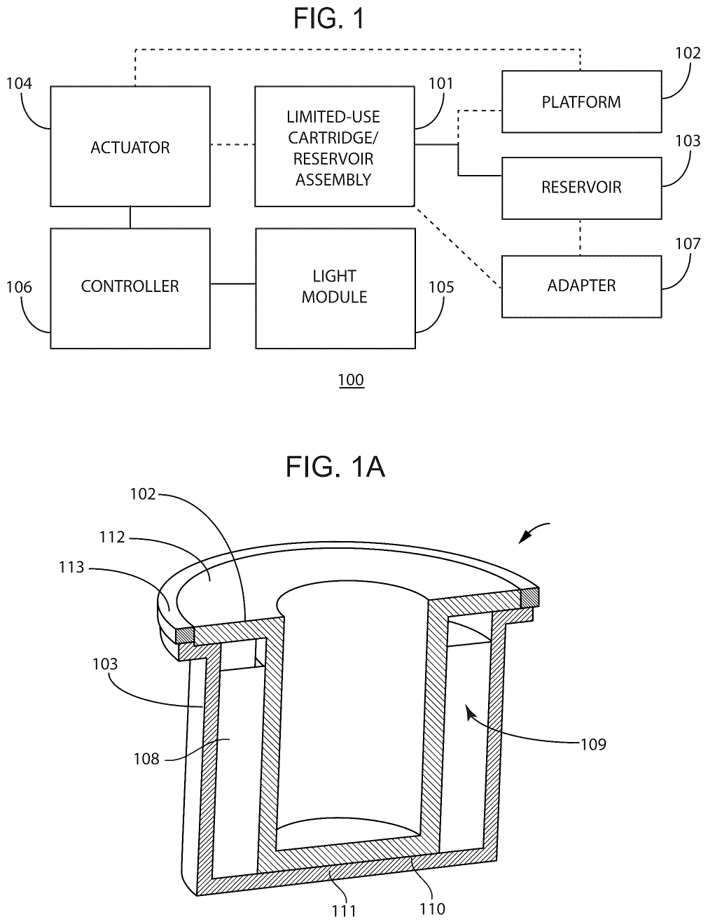

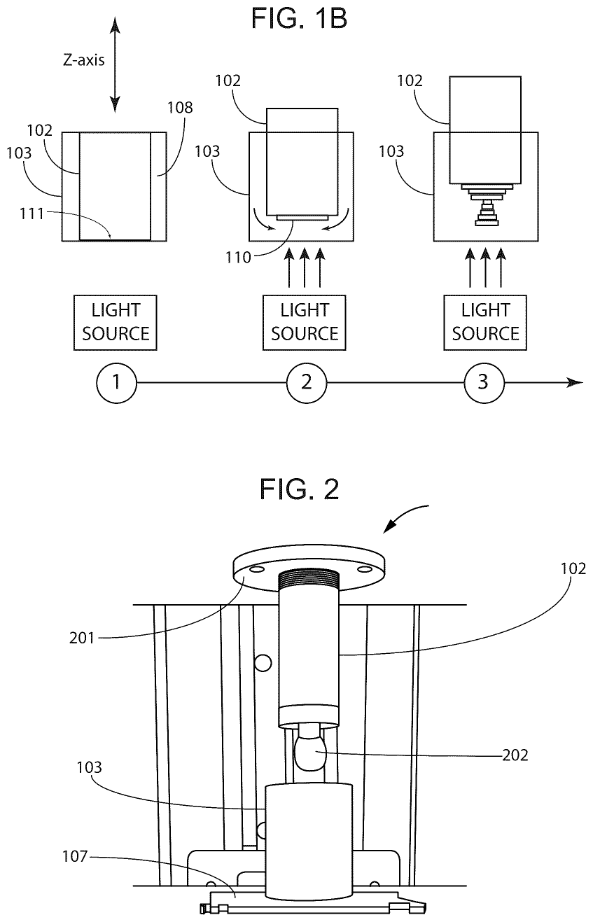

Turning first to FIG. 1, a block diagram for a system in accordance with some exemplary embodiments of the present invention is illustrated. More specifically, FIG. 1 depicts system 100, which includes a reservoir assembly 101, which houses a forming material such as a light-curable resin, a platform 102, which in some exemplary embodiments as discussed below may be a component of reservoir assembly 101 or a separate component than the reservoir assembly 101, a tank or reservoir 103 that houses the forming material and which generally is integral with the reservoir assembly 101, an actuator 104 for moving platform 102 along a z-axis in relation to the reservoir 103, a light module 105 for curing a layer of the forming material onto a surface of the platform or onto a previously cured layer of the forming material until a three-dimensional (3D) object is formed; and a controller 106 configured to actuate the platform and emit curable light into the reservoir in order to form the 3D object. Moreover, in some exemplary embodiments as will be discussed further below, one or more adapters 107 may be employed to adapt an existing additive manufacturing device such as a 3D printer, for utilizing a reservoir assembly in accordance with the present invention.

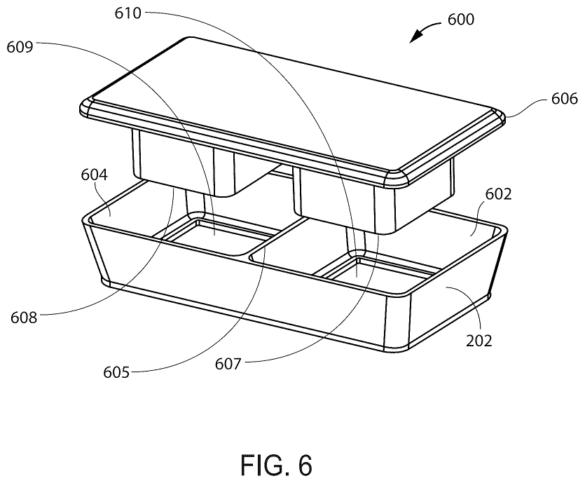

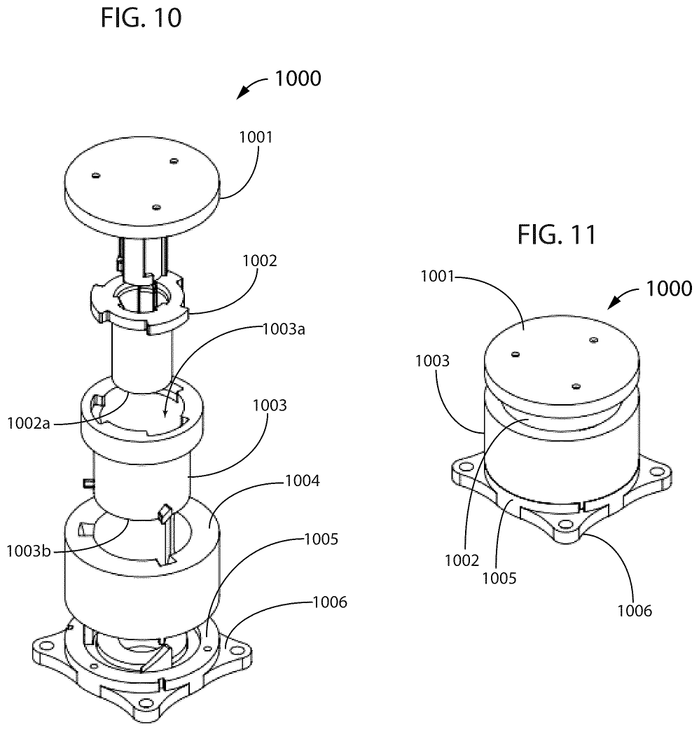

Reservoir assembly 101 is adapted to house a forming material such as a light-curable resin. In some exemplary embodiments, reservoir assembly 101 is a limited-use cartridge is pre-filled with enough forming material or resin to build a single 3D object such as, for example in the dental field, a single crown, a single dental appliance, or a single printable 3D object. In some exemplary embodiments, the cartridge is limited-use because once the 3D-printed object is formed, the cartridge may be disposed (i.e., single-use) or recycled. In embodiments of the present invention in which reservoir assembly 101 comprises a cartridge, the reservoir assembly 101 may comprise platform component that forms platform 102 on which the intended 3D object is formed or cured to during the forming process, and a reservoir component that forms reservoir 103 for securing and keeping fresh the forming material or resin intended to be used to form the 3D object. For example, and without limiting the scope of the present invention, see FIG. 1A, FIG. 6, FIG. 10, and FIG. 11, showing different embodiments of a limited-use cartridge in accordance with the present invention that include both a platform and reservoir within the cartridge or reservoir assembly.

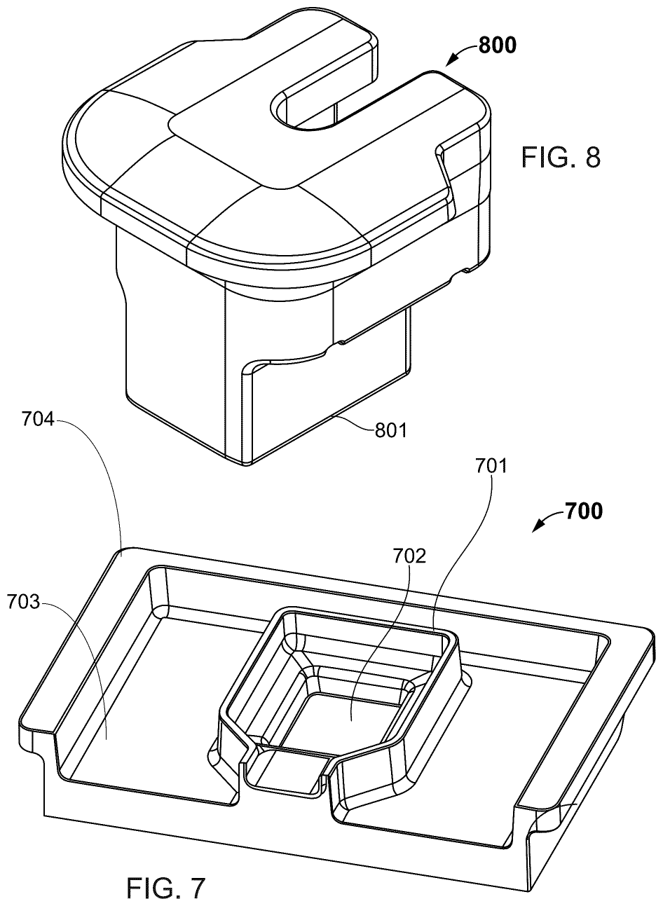

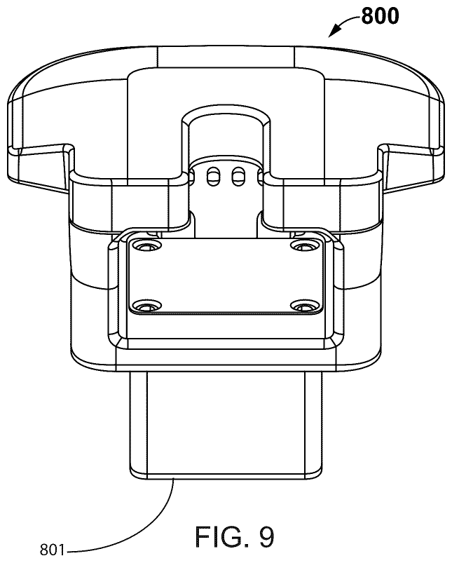

In yet other exemplary embodiments in accordance with the present invention, for example as shown in FIG. 7, FIG. 8, and FIG. 9, a reservoir assembly 101 may exclude platform 102. In embodiments in which reservoir assembly 101 excludes platform 102, system 100 nevertheless utilizes platform 102, except that platform 102 is a separate component—not integral with reservoir assembly 101—which is similarly actuated with actuator 104 that is configured to move platform 102 along a z-axis in relation to reservoir

103. Reservoir 103 is, in such exemplary embodiments, integral with reservoir assembly 101 so that a portion of reservoir assembly 101 forms the reservoir 103 that holds or houses the forming material or resin for forming the intended 3D object.

Platform 102, whether integral with or separate from reservoir assembly 101, includes a build surface adapted to receive a layer of the forming material that is typically cured onto the build surface to support the 3D object that is built onto the platform 102. As such, platform 102 should be constructed of a suitable material as it is understood in the art of additive manufacturing that is compatible with printing or forming materials.

Reservoir 103 is generally integral with or form part of reservoir assembly 101 and typically includes a transparent surface that both holds the forming material inside the reservoir 103 and allows a curing light through in order to cure a layer of the forming material onto the platform or onto a previously cured layer of the forming material in order to form or build the 3D object from the forming material onto the platform.

Actuator 104 is generally any suitable motor or movable component that may be configured to move platform 102 along a z-axis in relation to reservoir 103 during a forming or printing process to build the 3D object. In some exemplary embodiments, actuator 104 couples directly to a portion of the cartridge or reservoir assembly 101 (see for example FIG. or FIG. 10). In some exemplary embodiments, for example in which reservoir assembly 101 is not a cartridge and does not include platform 102, actuator 104 may couple directly with a component of platform 102 that is external to reservoir assembly 101 in order to move the platform during the formation process.

Light module 105 may be any suitable light source for curing the forming material into the intended 3D object. For example, and without limiting the scope of the present invention, because different forming materials are activated by different types of energy, light module may implement different components to project the suitable light in order to cure the forming material inside reservoir assembly 101. Thus, while in some embodiments light module may employ components for using blue or ultraviolet light or any other appropriate wavelength based on the properties of forming material to activate the forming agent, it will be appreciated by one of ordinary skill in the art that when a forming material or agent is used that requires other forms of energy, e.g., infrared light, laser light, X-rays, gamma radiation and the like, the light module should be suitably modified to generate and output such required energy. Therefore, for example, when infrared is projected onto the forming agent, the appropriate hardware and software must be employed so that a projector of light module 105 can generate and project such infrared light. Likewise, if X-rays or gamma radiation is used, the projector may be replaced entirely by an energy emitter that can produce and emit the appropriate energy format onto the forming agent.

In some exemplary embodiments, light module 105 may include multiple light engines that may be used to increase the maximum build space while maintaining a desired resolution. In such embodiments, the light engines may be placed inside a pre-designed fixture to maintain them in place. In some other embodiments one or multiple light engines may be used and translated at the same time over the build space to maintain a resolution while having the maximum build space. In some exemplary embodiments, multiple light engines may be employed to print multiple products that come in a single reservoir assembly 101 such as a cartridge with dual reservoirs and dual platforms suitable for forming two 3D products during a single batch; this configuration may be useful for printing products that may require different components with different forming materials that would otherwise require forming in separate batches. For example, and without limiting or deviating from the scope of the present invention, a set of dentures may be formed in a single batch with one reservoir of the reservoir assembly dedicated for the gums component of the dentures which requires a first type of forming material, and a second reservoir of the reservoir assembly dedicated for the teeth component of the dentures which requires a second type of forming material. See FIG. 6 as a non-limiting example of a reservoir assembly suitable for holding two forming materials and printing multiple 3D objects in a single build batch.

Controller 106 is a suitable controller in charge of receiving model data from a remote computer or locally to process images and to drive actuator 104 and control light module 105 in order for system 100 to form the intended 3D objects. To these ends, while multiple configurations for controller 106 may be possible without deviating from the scope of the present invention, controller 106 is generally configured to actuate platform 102 and emit curable light into the reservoir 103 in order to form the intended 3D object for which a suitable amount of forming material is included in a limited-use or short-term use reservoir assembly 101.

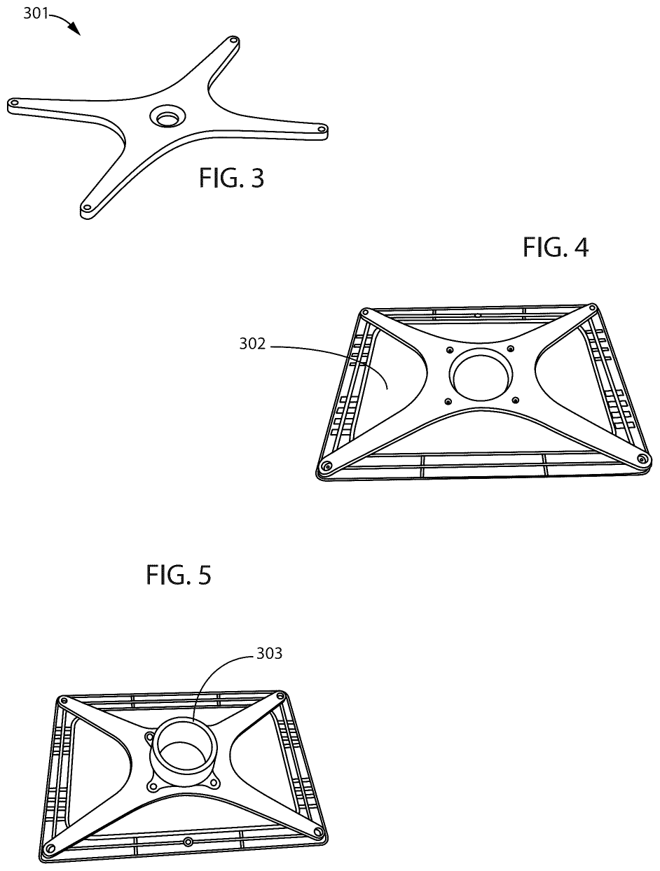

Moreover, in some exemplary embodiments as will be discussed further below, system 100 may include one or more adapters 107 for facilitating use of reservoir assembly 101 with conventional or existing additive manufacturing devices such as 3D-printers. For example, FIG. 3-FIG. 5 show an adapter assembly that retrofits or adapts a transparent substrate or glass of an existing light engine to receive a reservoir assembly or cartridge in accordance with some exemplary embodiments of the present invention. In another example, FIG. 7 shows an adapter that retrofits or adapts an existing tank to receive a reservoir assembly or cartridge in accordance with some exemplary embodiments of the present invention.

FIG. 1A illustrates a cut-sectional view of a cartridge in accordance with some exemplary embodiments of the present invention. More specifically, FIG. illustrates a cut-sectional view of reservoir assembly 101, which is a cartridge in accordance with exemplary embodiments of the present invention. As will be described below, in the embodiment of FIG., the reservoir assembly or cartridge 101 includes both a reservoir 103 that holds a forming material or resin 108, as well as a platform 102 that is movably built into the cartridge 101. In this embodiment, cartridge 101 is pre-filled and sealed with light-cured resin 108. This embodiment of cartridge 101 allows operators to go through a print or build process with minimal resin handling and eliminates the need to measure the amount of resin during setup. In some exemplary embodiments, the resin 108 is in a form of liquid or paste. The resin 102 is hardened using visible and/or ultraviolet (UV) light.

In this embodiment, cartridge 101 includes an outer housing that at least partially forms reservoir 103 and is adapted to receive platform 102 inside the housing. In exemplary embodiments, a cavity 109 is formed between platform 102 and the interior walls of reservoir 103, wherein cavity 109 is prefilled with, or otherwise suitable to receive, resin

108. In exemplary embodiments, the bottom surface 110 of platform 102 is a build surface onto which the intended 3D object is cured during a build process. In a sealed or prior to use state, platform 102 is secured against a bottom surface 111 of reservoir 103, which is transparent, optically clear, or otherwise configured to allow the passage of curing light, for example UV light, to allow polymerization during use of cartridge 101.

In an initial stage, or prior to being used, cartridge 101 is preferably sealed so that surface 110 of platform 102 is secured against surface 111 of reservoir 103, thereby preserving an integrity of the resin holding cavity 109 so that resin 108 stays fresh inside cartridge 101 prior to use. During operation, as shown in FIG., at step (1) cartridge 101 is situated or placed so that the cartridge 101 may be exposed to a curing light from a light module of system 100. In step (2), platform 102 is lifted or otherwise moved along a z-axis with reference to reservoir 103, so that surface 110 of platform 102 separates from surface 111 of reservoir 103, allowing resin 108 to flow from cavity 109 into the space between surfaces 110 and 111 of platform 102 and reservoir 103, respectively. This may be achieved via activating actuator 104 that has been adapted to move platform 102, for example up and down, so that platform 102 is lifted away from and lowered back to reservoir 103. In exemplary embodiments, an adapter 107 is utilized in order to secure cartridge 101 to a securing structure, for example a transparent support plate of the light module 105. During or in between movement of platform 102 along the z-axis, light module may be activated to a emit curing light and cure a layer of the resin 108 onto a surface of the platform 110. In step (3), the process of moving platform 102 and directing a light from the light module 103 into the reservoir through transparent surface 111 is repeated so that a 3D object may be formed layer by layer inside reservoir 103.

In some exemplary embodiments, cartridge 101 further comprises a penetrable layer or sealing layer 112 on its top side. The penetrable layer 112 is configured to seal the resin and secure platform 102 in place. As mentioned above, build surface 110 is a surface to which the printed part adheres during the printing process. In some exemplary embodiments, build surface 110 is configured to support the built part during the forming process. In some exemplary embodiments, platform 102 may include a dimension of about 2500 mm² or less. In some exemplary embodiments, build surface 110 allows for usage of application-specific containers to minimize resin waste during small print batches. In some exemplary embodiments, cartridge 101 and build surface 110 may be provided as a type of cartridge that may be used to build specific components, for example, a dental appliance. Once built, the cartridge 101 and build surface 110 or cartridge may be used up and disposed of or recycled.

As mentioned above, cartridge 101 comprises a surface 111, which is generally a print screen. In some exemplary embodiments, the print screen is the surface that allows light to pass through to cure the resin 108. The print screen may be bonded with the cured resin 108 however, the bond between print screen and resin is generally weak so that the 3D printed part, or each layer formed thereof, can be separated from the print screen in order to form the next layer.

In some exemplary embodiments, formation of the 3D object 200 occurs inside cartridge 101 that is pre-filled with the resin 108 as shown in FIG. 2. In some exemplary embodiments, a Z axis arm of a 3D printer includes a mating arrangement 201. The mating arrangement 201 is configured to mate with platform 102 of cartridge 101 and breaks a seal for forming material inside cartridge 101. Once the forming of the 3D object is completed, the 3D object or 3D-printed part 202 may be removed from cartridge 101 and platform 102 can be discarded or recycled. In this type of build platform configuration, a platform arm and the external additive manufacturing device components get very little exposure to the forming material (e.g., resin) and do not require user cleaning.

In another embodiment, the build surface 110 resides external to the cartridge 101. In some exemplary embodiments, the build surface 110 may be located on the Z axis arm of the 3D printer. In this arrangement, the build surface 110 resides on the Z axis arm. In some exemplary embodiments, build surface 110 has an arrangement that allows it to puncture the seal on the top side of the cartridge 101 and access the resin 102 to initiate the printing process.

In some exemplary embodiments, platform 102 interacts with a penetrable layer or sealing surface in different methods to access the forming material. The interaction methods may include a puncture interaction method and a built-in platform interaction method. In a puncture interaction method, the sealing surface of cartridge 101 may be punctured by the platform. In some exemplary embodiments, the puncture is designed to eliminate the contamination of resin from the seal.

In a built-in platform interaction method, the platform resides inside of cartridge 101. In some exemplary embodiments, a mechanism associated with the Z axis arm interacts with the platform and clutches the platform to initiate the printing process. There may be a couple of variations of this system. In some exemplary embodiments, the platform punctures a penetrable layer before initiating the printing process. In another embodiment, the penetrable layer moves and flexes according to the printing cycle. In some exemplary embodiments, the penetrable layer is made of a flexible material.

Referring to FIG. 3-FIG. 5, an adapter assembly is illustrated. More specifically, the adapter assembly shown is configured to retrofit or adapt an existing transparent substrate or glass of a light engine to receive a reservoir assembly or cartridge in accordance with some exemplary embodiments of the present invention. In exemplary embodiments, adapter components (108, 110, and 112) may interact with the cartridge 101 through either a mechanical fastening or a magnetic fastening. In some exemplary embodiments, the adapter components (108, 110, and 112) may be a fixed part, where it becomes a part of the additive manufacturing device, such as an existing 3D printer. In another embodiment, the adapter components (108, 110, and 112) may include removable parts, where the components sit securely on the printer and can be accessed or moved by the user.

For example, and without deviating from the scope of the present invention, FIG. 3 shows an exemplary reservoir assembly adapter frame 301 configured to couple to a screen or transparent plate 302 of a 3D printer, or a light module of a 3D printer (not shown). The reservoir assembly adapter frame 301 is also configured to receive a cartridge holder 303 shown in FIG. 5, to which a cartridge or reservoir assembly of a cartridge in accordance with the present invention may be secured to.

Referring to FIG. 6, an exploded view of a cartridge 600 of a single DLP printer is illustrated. In some exemplary embodiments, the single DLP printer is used to print with multiple materials at once. The single DLP printer comprises a platform that can be split but does not have independent z-axis controls. In some exemplary embodiments, cartridge 600 may be a disposable reservoir assembly that holds the print resin or forming material during the forming or printing process. In some exemplary embodiments, cartridge 600 is pre-filled with light-curable resin; in some exemplary embodiments, multiple types of curable resin may be sealed and stored in cartridge 600. To these ends, cartridge 600 comprises one or more compartments (602 and 604). The cartridge 600 physically separates the resin into separate compartments (602 and 604), which may be achieved with a divider 605.

In some exemplary embodiments, the cartridge 600 further comprises a platform 606 that includes multiple build surfaces 607 and 608. Cartridge 600 is similar to cartridge 101 as discussed above but includes multiple (i.e., in this case dual) reservoirs and dual built-in build surfaces 607 and 608 suitable for building components of a 3D-printed part that may require different materials or different parts, for example a set of dentures or a dental appliance. In some exemplary embodiments, cartridge 600 further comprises dual print screens or bottom surfaces 609 and 610 that are transparent and function similarly to surface 111—holding the forming material inside cartridge 600 and allowing suitable light to pass through in order to cure the forming material therein for building the intended 3D objects.

Referring to FIG. 7, a perspective view of a resin tank or reservoir assembly 700 is illustrated. Reservoir assembly 700 may be provided sealed and prefilled with resin, or may be simply provided for the user to fill with forming material as required. As such, this is an alternative to a cartridge configuration of the present invention, but to an embodiment in which a reservoir assembly is used in conjunction with a separate platform configured to register with reservoir assembly 700. In some exemplary embodiments, reservoir assembly 700 includes a reservoir 701 that is smaller in volume than conventional forming material tanks. The small volume is constrained to accommodate for a single model build. Reservoir assembly 700 is configured to house or hold a light curable resin or forming material. In some exemplary embodiments, reservoir 701 of reservoir assembly 700 is prefilled with forming material. In some exemplary embodiments, reservoir 701 of reservoir assembly 700 is geared towards maximizing the resin height with minimal cross-sectional area configured to optimize for the amount of resin being used.

In some exemplary embodiments, the minimal cross-sectional area of reservoir 701 supports up to one single 3D-printed object. For example, the minimal cross-sectional area is adapted to receive just enough forming material to build a single crown. The reduction in cross sectional area along with a build platform 800 (shown in FIG. 8) leads to displacement of the resin, allowing for easier flowing of the resin. In some exemplary embodiments, reservoir assembly 700 comprises a smaller print surface or print screen 702. In some exemplary embodiments, the smaller print screen allows for usage of alternate materials for optically clear printing surface.

In exemplary embodiments, as shown in the view of FIG. 7, an outer or surrounding surface 703 is configured to sit on a conventional forming material tank so that a conventional 3D printer, for example, may be retrofitted to be used with reservoir assembly 700 and thus in accordance with the present invention. A frame 704 may exemplarily support the surrounding surface 703 and hence the reservoir 701 of the reservoir assembly 700. During use, the reservoir assembly 700 may be simply placed over a conventional tank.

Referring to FIG. 8-9, different perspective views of a build platform 800 are illustrated. The build platform 800 is identical to a larger build platform. In some exemplary embodiments, build platform 800 comprises a z-axis arm. In some exemplary embodiments, build platform 800 further comprises a print area 801. Print area 801 of the build platform 800 may be modified to fit in the print screen 702 of reservoir assembly 700. In some exemplary embodiments, build platform 800 further comprises at least one built-in heater, for example a heater such as is described in U.S. patent application Ser. No. 17/990,256, which is incorporated by reference. Build platform 800 may employ a larger surface area exposed to the resin to achieve a faster heat up time.

Turning now to the next set of figures, FIG. 10 illustrates an exploded view of a cartridge in accordance with some exemplary embodiments of the present invention, and FIG. 11 illustrates a perspective view of a cartridge in accordance with the embodiment illustrated in FIG. 10. More specifically, cartridge 1000 is shown, including a platform adapter 1001 that both seals the cartridge and provides a connection means to an actuator or movement arm of an additive manufacturing device such as a 3D printer, a platform 1002, a reservoir assembly 1003 that is adapted to register with platform 1002, a reservoir assembly adapter body 1004 configured to receive at least a portion of the reservoir assembly 1003 of the cartridge 1001, a locking or releasing mechanism 1005, and an adapter base 1006 configured to secure cartridge 1001 to the additive manufacturing or printing device (not shown).

In some exemplary embodiments, cartridge 1000 comprises a single-use cartridge for building a three-dimensional (3D) object using an additive manufacturing device. In exemplary embodiments, the cartridge includes a reservoir assembly 1003 including a reservoir 100 sealed and prefilled with a forming material; a transparent layer 100 adapted to hold the forming material inside the reservoir 100, the transparent layer 100 further adapted to allow polymerizing light to pass through for polymerization of at least a layer of the forming material; and a platform 1002 slidably housed inside the reservoir assembly adapted to move vertically along a z-axis in relation to the transparent layer 100 and adapted to support a 3D object built on a surface 100 of the platform 1002.

In some exemplary embodiments, reservoir 100 includes a divider (not shown in this view, but see FIG. 7) that divides the reservoir into multiple reservoirs adapted to hold one or more types of forming materials; and the platform includes multiple build surfaces adapted to register with each of the multiple reservoirs.

In some exemplary embodiments, a cavity is formed between the platform and the reservoir assembly to hold the forming material inside the cavity. In some exemplary embodiments, movement of the platform during use of the cartridge exposes the forming material inside the cavity to the built surface of the platform (see for example, FIG. 1A).

In some exemplary embodiments, cartridge 1001 further comprises a penetrable layer or sealing surface on a top side or bottom side of the cartridge configured to secure the platform inside the reservoir when the cartridge is in a sealed state. In some exemplary embodiments, the sealing surface is made of a flexible material that moves and flexes according to a forming cycle.

In some exemplary embodiments, cartridge includes platform adapter 1001, which is configured to connect the platform to an actuator of the additive manufacturing device (for example a print arm (not shown in this view)). In some exemplary embodiments, platform adapter 1001 is configured to puncture a penetrable layer sealing the forming material inside reservoir 100 of reservoir assembly 1003.

In some exemplary embodiments, as shown, cartridge 1001 further includes reservoir assembly adapter 1005 configured to secure the reservoir assembly 1003 to a light module of the additive manufacturing device. In some exemplary embodiments, the reservoir assembly adapter 1005 interacts with the reservoir assembly via a mechanical fastener or a magnetic fastener device incorporated therein. A base 1006 may be configured to secure the adapter in place to a preexisting printer or additive manufacturing device.

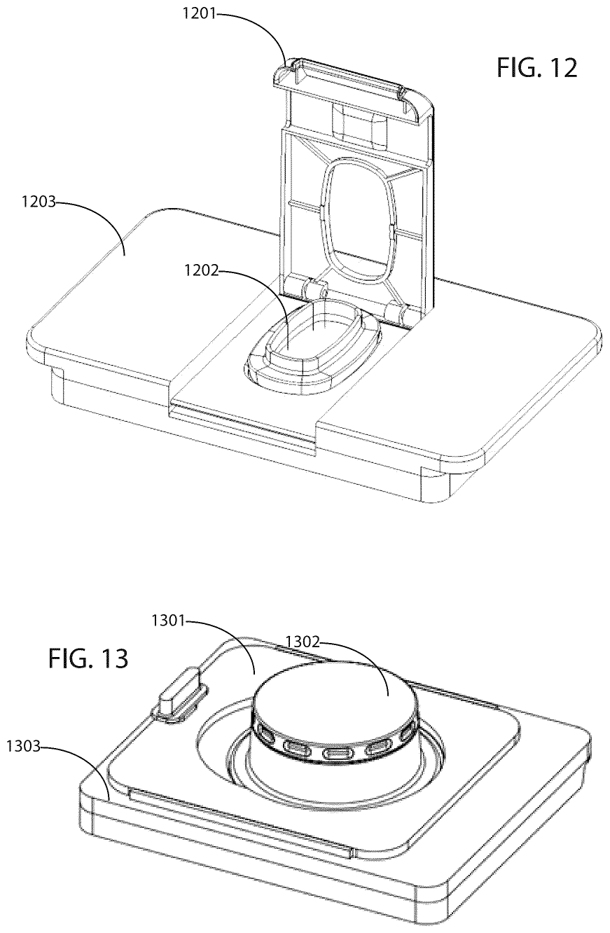

FIG. 12-FIG. 17 illustrates different perspective views of adapters in accordance with some exemplary embodiments of the present invention. More specifically, these figures show different types of adapters that secure a cartridge in accordance with the present invention to an existing printer or additive manufacturing device.

FIG. 12 shows a latch-based assembly, which includes a latch locking mechanism 1201, a cartridge receiving aperture 1202, and an adapter base 1203. In this mechanism, the cartridge is grabbed by a latch built onto the adapter. This latch can open to the top or to the sides.

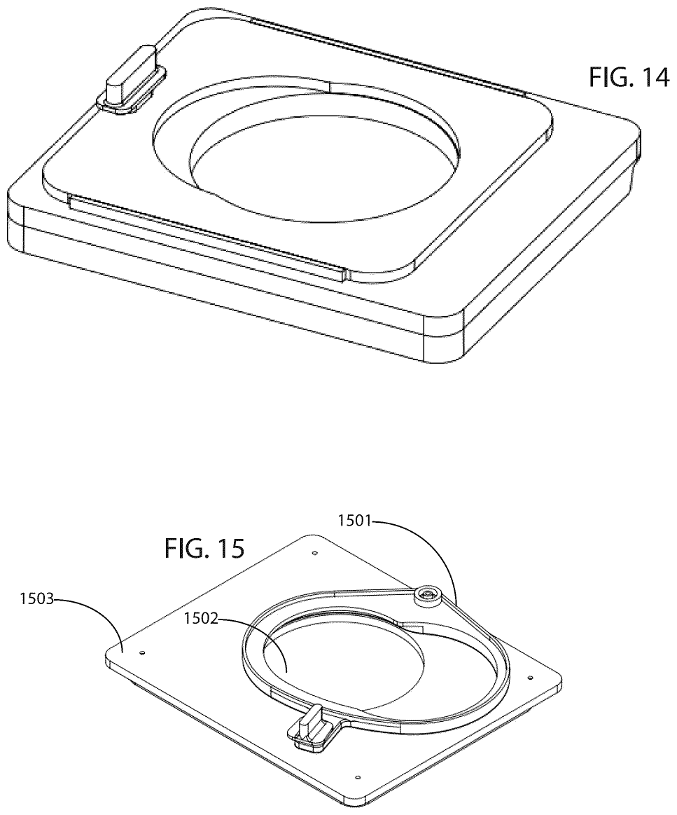

FIG. 13 shows a slider-based assembly, which includes a cartridge receiving aperture 1302 (shown with a cartridge secured therein), a latch locking mechanism 1301, and an adapter base 1303. In this mechanism, the cartridge is held by a feature on the adapter which is engaged/disengaged with the help of a slider. FIG. 14 shows the same components without the cartridge installed therein.

FIG. 15 shows a swing-based assembly, which includes a cartridge receiving aperture 1502, a locking mechanism 1501, and an adapter base 1503. In this mechanism, a swing on the adapter is used to engage/disengage the cartridge. The swing can be operated manually by the user or can be engaged electronically.

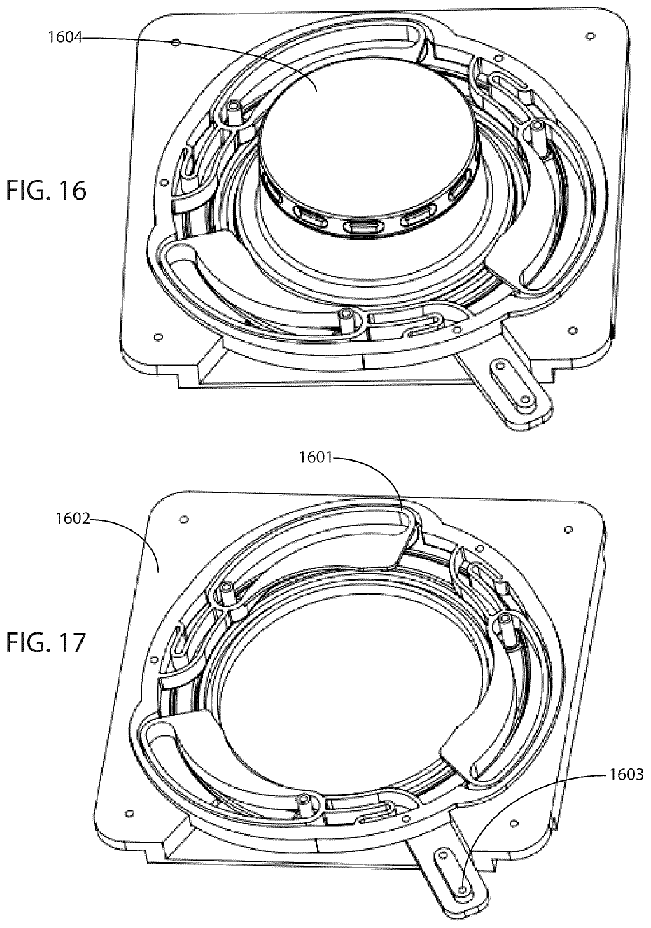

FIG. 16 and FIG. 17 show an aperture-based assembly, which includes a cartridge receiving aperture 1600, shown with a cartridge 1604, an aperture locking mechanism 1601, and an adapter base 1603. In this mechanism, the cartridge is engaged/disengaged via mechanical features similar to one employed by a camera. The aperture is decreased to engage the cartridge and is increased to disengage. This mechanism can be triggered manually by the user or electronically.

Advantageously, in some exemplary embodiments, the container of the present invention allows operators to go through the printing process with minimal resin handling, which eliminates the need to measure the resin during setup. The build platform arm and the external printer features get very little resin exposure and do not require user cleaning. The build platform is utilized for application-specific containers to minimize the resin waste during the small print batches. The container is used to print with multiple materials at once. Further, the container and build platform may be disposable or single use.

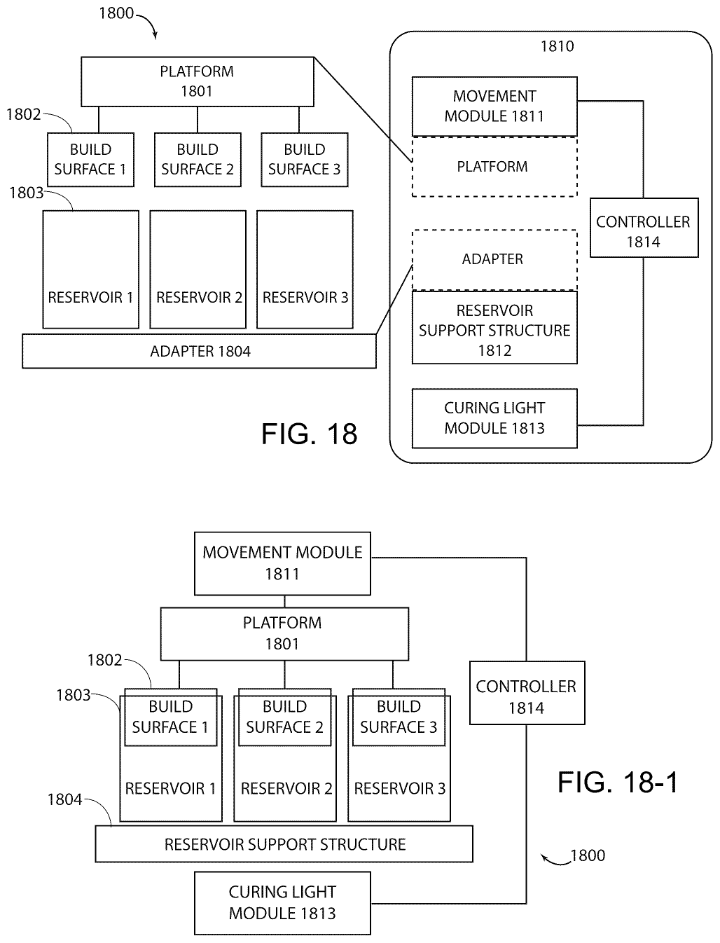

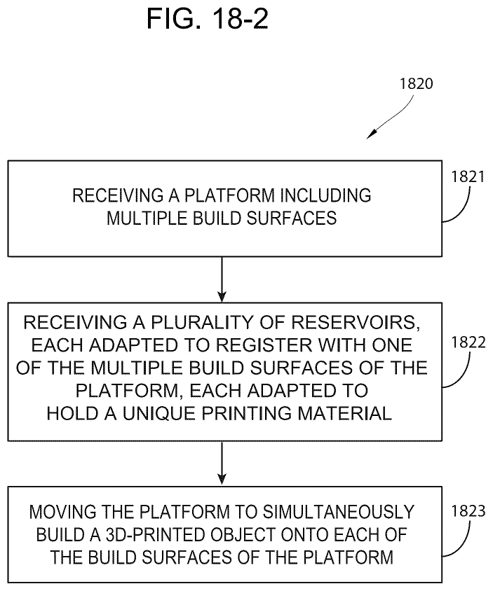

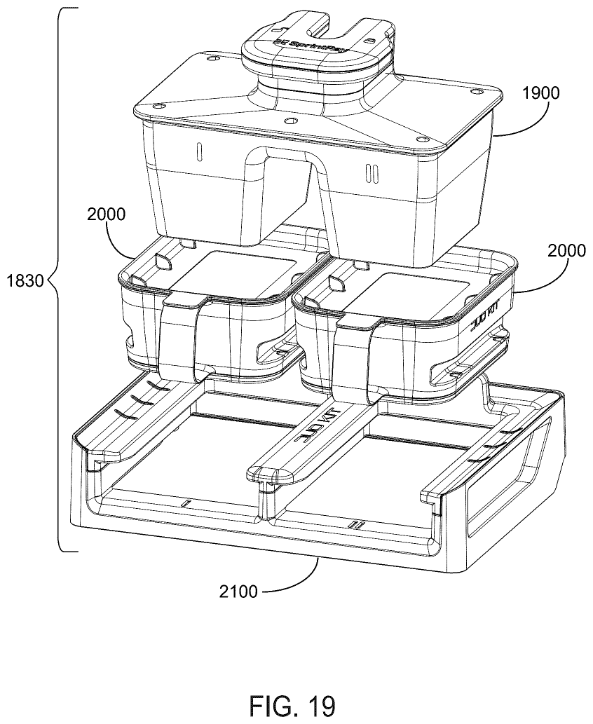

Turning now to the next set of figures, another aspect of the present invention is disclosed in FIG. 18 (a block diagram of a device or kit in accordance with some exemplary embodiments of the present invention), FIG. 18-1 (a block diagram of a system in accordance with some exemplary embodiments of the present invention, FIG. 18-2 (a flow chart of a method in accordance with some exemplary embodiments of the present invention), and FIG. 19 (an exploded view of a 3D printing kit in accordance with the present invention).

Generally, embodiments of a printing device is illustrated in these views, which may be a single device, or a system—such as a kit—for retrofitting an existing 3D printer to print multiple 3D objects or multiple three-dimensional components of a single object simultaneously; meaning during the same printing run of the 3D printer.

In some embodiments, and in no way limiting the scope of the present invention, the kit may be a dual printing kit—with components suitable for retrofitting an existing 3D printer to print two 3D objects simultaneously. Naturally, instead of “dual” the kit may be adapted to print three, or four, or any feasible plurality of 3D objects. The 3D objects may be a wide variety of 3D objects, and may be related or unrelated. When the 3 objects relate to a single component or print job, the present invention has proven to be most efficient, as discussed further below. For example, and without limiting the scope of the present invention, a system in accordance with this aspect of the invention may be used to print 3D objects such as dental components or dental appliances using biocompatible resins suitable for the same. In some exemplary embodiments, the 3D objects may include dentures, nightguards, aligners, crowns, just to name a few non-limiting examples. In the case of dentures, for example, the gums portion of the dentures may be built using a first set of one or more biocompatible resins or printing materials stored in a first reservoir; and the teeth portion of the dentures may be built using a second set of one or more biocompatible resins or printing materials stored in a second reservoir. The 3D-printed gums may be built onto a first build surface of the platform, while the teeth portion may be built onto a second build surface of the platform. Both components of the 3D-printed dentures (i.e., the teeth and gums) may be built or printed simultaneously or on a single run of the 3D printer; as the platform of the printer is activated both components of the dentures are built at the same time. In this way, the building of the 3D-printed dentures is more efficient.

Similarly, in the case of nightguards or aligners, or even crowns-treatments that often require several similar but not identical components, it is useful to build or print multiple versions simultaneously or on a single run of the 3D printer; as the platform of the printer is activated multiple complementary or corresponding components (i.e., of the desired nightguards, aligners, or set of crowns) are built at the same time.

In some exemplary embodiments, a dual material system may comprise a kit/The kit may include: a dual build platform, a dual resin tank or reservoir, and an adapter. The dual build platform includes two build surfaces on a single platform, which are independent of each other—that is each build surface is adapted to receive thereon a 3D printed object that is polymerized on that build surface only; each build surface is dimensionally and positionally matched to the corresponding reservoir. The reservoirs are also independent of each other so that each reservoir is adapted to hold a unique printing material, meaning the printing material in each reservoir is suitable for printing a 3D object on a corresponding build surface of the platform only. In some embodiments, as will be discussed below, a unique printing material in one reservoir may differ in composition from a unique building material in a second reservoir (e.g., when building dentures the printable resin suitable for the dentures is typically a different composition than the printable resin for building the teeth portion of the dentures). Moreover, an adapter may be provided with the system in order to facilitate securing the reservoirs to an existing base or support structure of an existing 3D printer, and also to align the reservoirs with each of the build surfaces of the platform. As mentioned above, this device configuration enables the simultaneous printing with two different photopolymer resins, significantly reducing overall printing time and improving printing efficiency.

Turning now specifically to FIG. 18, a 3D printing system or kit, suitable for retrofitting a 3D printer to print multiple 3D-printed objects, is illustrated. More specifically, this figures depicts system or kit 1800, which comprises a platform 1801 adapted to be used with 3D printer 1810, the removable platform 1801 including a plurality of build surfaces 1802 (i.e., although three build surfaces are shown, platform 1801 may include just two build surface, or four, or five, etc. without deviating from the spirit or scope of the present invention). Accordingly, platform 1801 is typically removable so that a user can retrofit their existing 3D printer with the capabilities of the present invention. As will be discussed below, in some embodiments a printer dedicated for the purposes described here may be provided without deviating from the scope of the present invention—and in those embodiments platform 1801 may not necessarily be removable or interchangeable with other platforms. In exemplary embodiments, platform 1801 is however removable.

Moreover, system 1800 further comprises a plurality of reservoirs 1803 adapted to register with the plurality of build surfaces 1802 of the platform 1801. In exemplary embodiments, each reservoir is sealable so that the reservoirs may be provided to a user pre-filled with printable material suitable for specific 3D object or component for a 3D object as discussed above. Accordingly, although not necessary, reservoirs 1803 may be sealable and store a unique printing material inside ready for use (as will be discussed further below). In other exemplary embodiments, the reservoirs may be sealable are not prefilled with printing material or resin; in such exemplary embodiments, before printing, a user needs to pour the printing material or resin into the reservoir to start the printing.

Moreover, system 1800 further comprises an adapter 1804 configured to secure the plurality of sealable reservoirs 1803 to a base of 3D printer 1810 in a manner so that: each of the plurality of sealable reservoirs 1803 are aligned with a curing light module 1813 of 3D printer 1810, and each of the plurality of sealable reservoirs 1803 is aligned and registers with a corresponding build surface of the plurality of build surfaces 1802 of the platform 1801.

Accordingly, providing removable platform 1801 (which includes the plurality of independent build surfaces 1802), plurality of reservoirs 1802, and adapter 1803, facilitates the retrofitting of existing 3D printer 1810 for simultaneous printing in accordance with the present invention, including without limitation, enabling the simultaneous printing of multiple components or complementary 3D objects with multiple different photopolymer resins during a single print job-significantly reducing overall printing time and improving printing efficiency. For example, platform 1801 may be coupled to a movement module of 3D printer 1810 (typically an actuator or motor including an arm capable of moving the platform during the build process), and adapter 1803 may be coupled to a base of 3D printer 1810 such as a reservoir support structure that is suitable for receiving a reservoir for that 3D printer. As such, adapter 1804 typically includes a geometry that registers with support structure 1812 of 3D printer 1810. In some exemplary embodiments, adapted 1804 is adapted to couple or register with a body or housing of curing light module 1813. For example, and without limiting the scope of the present invention, adapter 1804 may include a geometry, perimeter, or coupling that otherwise match or are designed to register with a body of the curing light module of the existing printer, such as a display cartridge (e.g., an LCD display cartridge) or housing that forms part of curing light module 1813. In this way, the transparent substrate that forms a base of each reservoir is adequately positioned by way of the adapter 1804 in alignment with both platform and curing light engine of the existing 3D printer.

As mentioned above, reservoirs 1803 are removably coupled to adapter 1804 so as to align the reservoirs with the platform (secured to 3D printer 1810) and curing light module 1813 of 3D printer 1810. Once the components of system 1800 are in place, controller 1814 of 3D printer 1810 may be configured to move the platform thereby simultaneously moving the plurality of build surfaces to facilitate the polymerization of each unique printing material in each reservoir onto the build surfaces—layer by layer—to build a 3D-printed object onto each of the build surfaces of the platform. In exemplary embodiments, controller 1814 may be configured to control the curing light exposure timing in order to address any multiple different printing materials having different cure-times; that is, a suitable algorithm or software executable by controller 1814 may be configured to control the curing light exposure time accordingly, whereby the shorter cure-time job lights off first, leaving it to rest until the longer cure-time job finishes. Independent control of the curing light exposure towards one of the multiple reservoirs is desirable to address curing times as well as 3D objects with different heights or dimensions. For example, and without limiting the scope of the present invention, if part A is being built on a first reservoir and that part is 2 cm in height, and part B is being built on a second reservoir and is 3 cm in height, printing parts A and B may be started simultaneously by projecting separate patterns for each. Once part A is finished, controller 1814 can stop light module 1813 from projecting a pattern for part A and continue projecting a pattern for B until part B is completed.

FIG. 18-1 depicts a similar system but one that incorporates each component-platform, reservoirs, and reservoir support structure, as a single integral 3D printer. As may be appreciated by a person of ordinary skill in the art, there are advantages to having a dedicated device for the purposes of the present invention, but there are also advantages to being able to retrofit an existing printer into a printer that enables the functionalities in accordance with the present invention.

Turning now to the next figure, FIG. 18-2, a flow chart of a method in accordance with some exemplary embodiments of the present invention is illustrated. More specifically, FIG. 18-2 illustrates a flow chart of method 1820 performed by a 3D printer, for simultaneously printing components of a dental appliance. It should be understood that although presented in a particular sequence, the steps of method 1820 may include additional steps, with more or less steps in different embodiments, or even in a different sequence, without deviating from the scope of the present invention.

In step 1821, a removable platform adapted to be used with the 3D printer may be received, wherein the removable platform includes a plurality of build surfaces. This may include, for example, the coupling or connecting of platform 1801 to printer 1810—in some exemplary embodiments, 3D printer may detect that the printing platform is secured in place and ready for a printing job.

In step 1822, a plurality of sealable reservoirs, each adapted to register with one od the multiple build surfaces of the platform, and each adapted to hold a unique printing material, may be received. This may include, for example, securing the plurality of sealable reservoirs 1803 to a base of the 3D printer 1810 by way of adapter 1804 in a manner so that each of the plurality of sealable reservoirs 1803 are aligned with curing light engine 1813 of 3D printer 1810, wherein the sealable reservoirs 1803 are further adapted to register with the plurality of build surfaces 1802 of the platform 1801.

In step 1823, moving platform 1801 and projecting a curing light to simultaneously build a 3D-printed object onto each of the build surfaces 1802 of platform 1801. As referenced above, this step may include controlling the curing light module 1813 in a manner so that, as multiple different printing materials may have different cure-times or different 3D objects may have different dimensions, a suitable algorithm or software executable by controller 1814 may be configured to control the cure light exposure time towards each respective reservoir accordingly.

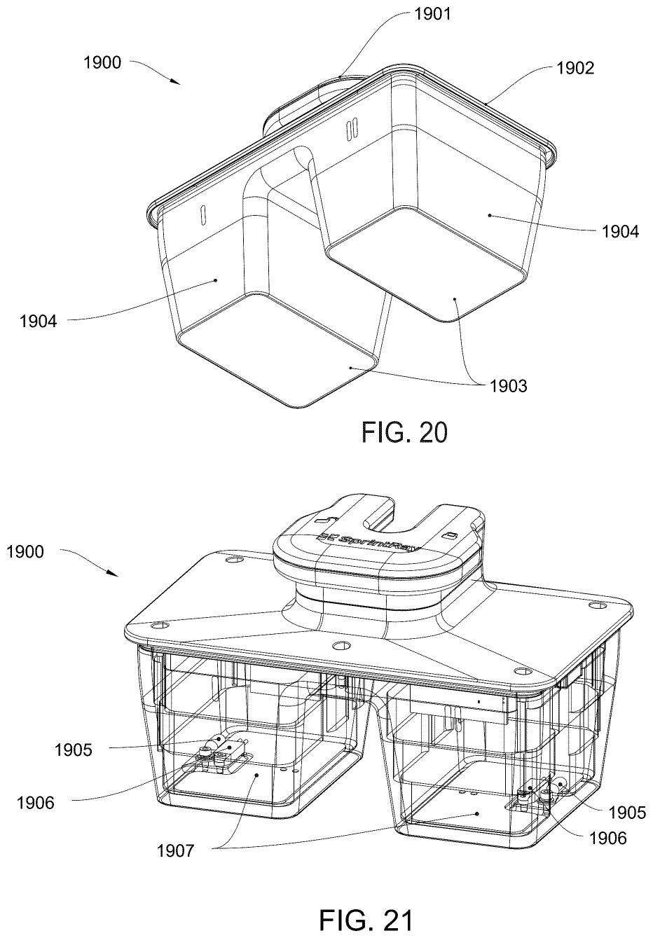

Turning now to the next set of figures, FIG. 19-FIG. 32 illustrate various views of a multi-material printing kit in accordance with exemplary embodiments of the present invention. FIG. 19 illustrates an exploded view of a 3D printing kit in accordance with the present invention. More specifically, FIG. 19 illustrates a dual material printing kit 1830, which includes platform 1900, two reservoirs 2000, and an adapter 2100, wherein platform 1900 includes two distinct and independent build surfaces 1903 (see FIG. 20) and the plurality of reservoirs 2000 are adapted to register with the plurality of build surfaces 1903 of the platform 1900. In some exemplary embodiments, such as the one shown in these views, platform 1900 is defined at least in part by a main body from which multiple platform bodies 1904 extend to a terminal surface that forms each of the plurality of build surfaces 1903. That is, each of the plurality of build surfaces 1903 comprise of a surface on one of the multiple platform bodies 1904 that form platform 1900.

In some exemplary embodiment, each of the plurality of reservoirs 2000 may be adapted to store a unique printing material and register with a corresponding build surface 1903. In this mechanism, each of the plurality of reservoirs 2000 may be dimensionally and positionally matched to a corresponding build surface of the plurality of build surfaces 1903. In some exemplary embodiments, each of the plurality of reservoirs 2000 may be adapted to operate independently of the other reservoirs of the plurality of reservoirs 2000, meaning that each reservoir may be independently removed or secured to adapter 2100, and that each reservoir may be used to independently build a 3D object that is distinct from a 3D object built in an adjacent reservoir. Notable, although platform 1900 essentially controls the simultaneous movement of each build surface 1903, as discussed above the curing light engine may be configured to address varying material curing times and 3D object dimensions by directing the appropriate light pattern for the appropriate timing towards each reservoir region adapted to receive the curing light. In this way, different 3D objects with different printing materials may be printed or built simultaneously.

As illustrated in FIG. 19 and FIG. 27-1, the adapter 2100 may be adapted to register with the plurality of reservoirs 2000. In some exemplary embodiments, the adapter 2100 may be employed to adapt an existing additive manufacturing device such as a 3D printer for retrofitting a 3D printer to print multiple 3D-printed objects by utilizing a 3D printing kit in accordance with the present invention. In some exemplary embodiments, the adapter 2100 may be configured to secure the plurality of reservoirs 2000 to a 3D printer. In some exemplary embodiments, the adapter 2100 may be affixed or removably coupled to the 3D printer.

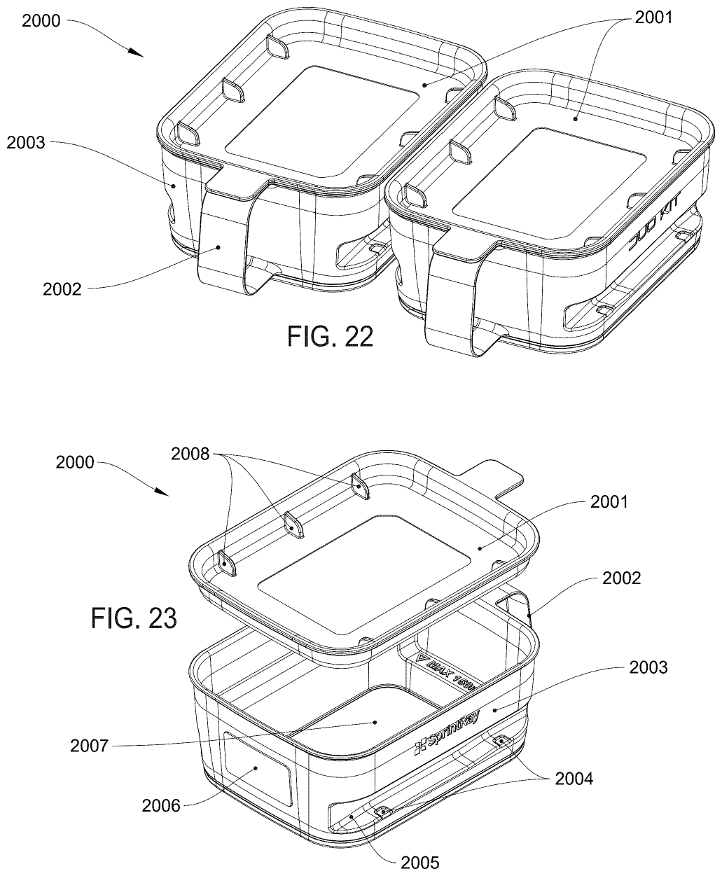

In some exemplary embodiments, the 3D printing kit may be a dual material kit. In some exemplary embodiments, the platform 1900 may be a dual build platform with a first build surface and a second build surface as illustrated in FIGS. 19 and 20. In some exemplary embodiments, the plurality of reservoirs 2000 may be a dual resin tank with first resin tank and a second resin tank as illustrated by FIGS. 19 and 22, wherein the first reservoir may be adapted to store a first printing material and the second reservoir may be adapted to store a second printing material.

FIG. 20 illustrates a posterior bottom perspective view of a platform of a 3D printing kit in accordance with the present invention. As illustrated in FIG. 20, the platform 1900 may include a platform handle 1901, a platform cover 1902, and multiple build platform bodies 1904, wherein each one of the multiple build platforms bodies includes a build surface 1903. In some exemplary embodiments, the multiple build platform bodies 1904 are mechanically fixed to each other, and in some embodiments as depicted in this view, are integral with a body of platform 1900.

In some exemplary embodiments, the platform handle 1901 may be adapted to facilitate the handling of the platform by a user of a 3D printing kit in accordance with the present invention. In some exemplary embodiments, platform handle 1901 may be further adapted to secure the platform 1900 onto a 3D printing device. For example, an in no way limiting the scope of the present invention, in some exemplary embodiments the platform 1900 may be secured to a printing arm of a 3D printing device. In some exemplary embodiments, as illustrated in FIG. 21, the platform handle 1901 may include a U-shaped concavity to facilitate the securing of the platform handle 1901 to a 3D printing device. In other exemplary embodiments, other shapes and structural architypes for the platform handle 1901 may be implemented for the purpose of securing said platform handle 1901.

In some exemplary embodiments, the lower part of the platform handle 1901 may be removably fixed to the platform cover 1902 by a securing mechanism. For example, and in no way limiting the scope of the present invention, the securing mechanism may include a plurality of nuts and bolts situated along the outer edges of the lower part of the platform handle 1901 and an upper center area of the platform cover 1902.

In some exemplary embodiments, the platform cover 1902 may be removably fixed to the multiple build platform bodies 1904. For example, and in no way limiting the scope of the present invention, the securing mechanism may be a plurality of nuts and bolts situated along the outer edges of the platform cover 1902 and the upper part of the multiple build platform bodies 1904. In some exemplary embodiments, the securing mechanism is adapted to fix and seal the multiple build platform bodies 1904 to prevent any material such as a photopolymer resin or other debris from entering the multiple build platform bodies 1904.

In some exemplary embodiments, the multiple build platform bodies 1904 are arranged parallel to one other and each of the multiple build platforms may include a build surface 1903. In some exemplary embodiments, each build surface 1903 may be adapted to independently build a 3D printed object while being positioned on the same horizontal plane as each other build surface 1903 to facilitate the simultaneous creation of multiple 3D-printed objects. In some exemplary embodiments, each build surface 1903 may be adapted to facilitate the polymerization of a unique printing material. For example, and in no way limiting the scope of the present invention, each build surface 1903 may be adapted to facilitate the polymerization of a unique photopolymer resin. In some exemplary embodiments, the material comprising the build platform 1904 may be a hard anodized aluminum with a laser-etched pattern to optimize adhesion. In other exemplary embodiments, the build platform 1904 of a 3D printing kit may be comprised of other materials that optimize adhesion as known by those of ordinary skill in the art.

FIG. 21 illustrates an isometric side view of a platform of a 3D printing kit in accordance with the present invention, further illustrating a detailed view of the interior of the multiple build platforms. In some exemplary embodiments, as illustrated in FIG. 21, the interior of the multiple build platform bodies 1904 may include a temperature sensor 1905, an overheat protection device 1906, and a heating pad 1907, wherein the heating pad 1907 may be adapted to heat each of the multiple build platform bodies 1904 to ensure uniform temperature distribution during the printing process and ensure more even heating of the photopolymer resin. In some exemplary embodiments, the heating pad 1907 may be further adapted to independently heat each of the multiple build platform bodies 1904 based on the type of printing material used to print the 3D-printed object.

In some exemplary embodiments, the heating pad 1907 may be adapted to reach a maximum temperature. For example, and in no way limiting the scope of the present invention, the heating pad 1907 may be adapted to heat up to a maximum temperature of 40° C. In some exemplary embodiments, the temperature sensor 1905 may be configured to dynamically monitor the heating temperature of each of the multiple build platform bodies 1904 in real-time. In some exemplary embodiments, the overheat protection device 1906 may be adapted to deactivate the heating pad 1907 when the temperature of the multiple build platforms exceeds a certain threshold to prevent the heating pad 1907 from malfunctioning or causing burns to the user due to excessive temperature.

FIG. 22 illustrates an isometric side view of the plurality of tanks of a 3D printing kit in accordance with the present invention. In some exemplary embodiments, as shown in FIG. 22, each reservoir 2003 of the plurality of reservoirs 2000 may include a reservoir cover 2001, wherein each reservoir 2003 is adapted to sealably store a printing material. In some exemplary embodiments, the reservoir cover 2001 may be removably positioned at the top of each reservoir 2003. In some exemplary embodiments, the material of the reservoir cover 2001 may be rubber. For example, and in no way limiting the scope of the present invention, the material of the reservoir cover 2001 may be a thermoplastic polyurethane (TPU) or some other material with rubber and plastic properties. When a reservoir 2003 is in an idle state, the reservoir cover 2001 may be placed on top of said reservoir 2003 to prevent the printing material stored inside the reservoir 2003 from deteriorating due to air or light exposure from the external environment. Each reservoir 2003 of the plurality of reservoirs 2000 is adapted to be independent of the other reservoirs of the plurality of reservoirs 2000 and is adapted to store a unique printing material. For example, and in no way limiting the scope of the present invention, each reservoir 2003 may store a unique photopolymer resin. In other exemplary embodiments, each reservoir 2003 of the plurality of reservoirs 2000 may store the same printing material. In some exemplary embodiments, the plurality of reservoirs 2000 may be a dual reservoir including a first reservoir and a second reservoir, the first reservoir storing a first printing material and the second reservoir storing a second printing material, wherein the first printing material and the second printing material are two different types of photopolymer resins.

FIG. 23 illustrates an exploded view of one of the plurality of reservoirs of a 3D printing kit in accordance with the present invention. In some exemplary embodiments, as illustrated in FIG. 23, each reservoir 2003 may include a handle 2002, an RFID tag 2006, and a membrane 2007. In some exemplary embodiments, the handle 2002 may be positioned on the side of each reservoir 2003 such that the handle 2002 is facing the user and is adapted to facilitate the user's handling of the reservoir 2003. In some exemplary embodiments, the RFID tag 2006 is situated on the rear side of each reservoir 2003, wherein the RFID tag 2006 is adapted to detect whether the reservoir 2003 is connected to the adapter 2100 of a 3D printing kit in accordance with the present invention. In some exemplary embodiments, the RFID tag 2006 will connect with a reader 2102 positioned inside the rear side of the adapter 2100 when the reservoir 2003 is pushed into the adapter 2100. The reader 2102 may be adapted to recognize and read information stored in the RFID tag 2006, indicating that the reservoir 2003 is connected to the adapter 2100. In some exemplary embodiments, the RFID tag 2006 may be writable and adapted to store relevant information about the reservoir 2003. For example, and in no way limiting the scope of the present invention, the RFID tag 2006 may include information regarding the amount of print material stored within the reservoir 2003, the type of print material stored inside the reservoir 2003, and the number of remaining print cycles.

In some exemplary embodiments, the reservoir also includes a membrane 2007 positioned at the bottom of the reservoir 2003. In some exemplary embodiments, the membrane 2007 may comprise of a material that enhances durability and lifespan when exposed to highly corrosive print materials. For example, and in no way limiting the scope of the present invention, the material of a membrane may be ACF-5 to enhance the lifespan of the reservoir 2003 adapted to store highly corrosive photopolymer resins.

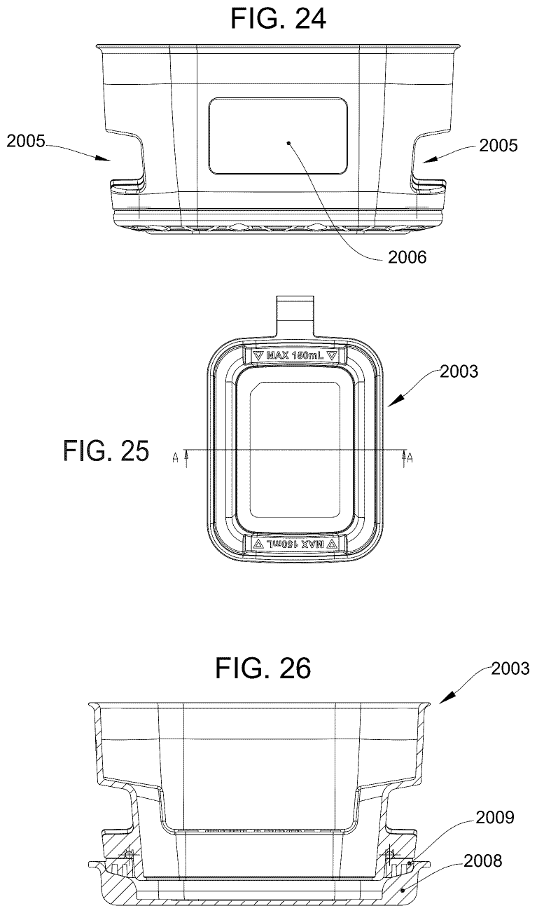

FIG. 24 illustrates a rear view of a reservoir of a 3D printing kit in accordance with the present invention. As illustrated in FIG. 24, each side of each reservoir 2003 includes an insertion space 2005, which matches the protruding portion 2103 of the base bracket of the adapter 2100. The protruding portion 2103 extends into the adapter's fitting area for each reservoir 2003. Along the direction of insertion/removal of the reservoir 2003, two positioning beads 2104 are positioned beneath the protruding portion 2103. The positioning beads 2104 match the grooves 2004 of the reservoir 2003, thereby securing the reservoir 2003 in the adapter 2100.

Alternatively, the positioning beads 2104 can be positioned above or on the side of the protruding portion 2103, and the size and position of the positioning beads 2104 are matched with the grooves 2004 which are positioned above or on the side of the insertion spaces 2005 of the reservoir 2003. The number of positioning beads 2104 can be one or more. Alternatively, other mechanical structures capable of achieving positional locking can also be used in place of the positioning beads 2104. Preferably, the height of the insertion channel or space 2005 gradually converges along the direction of insertion of the reservoir 2003; this way, when the reservoir is pushed in, it will be smoother, providing a better tactile experience for the user. Moreover, in exemplary embodiments, the locking mechanism utilizes one or more grooves 2004 in which one or more (for example, four) detents provide a retention force by compressing downward to secure the reservoir in position. An insertion channel along a depth of insertion spaces 2005 serves primarily as a guide to ensure proper alignment during tank installation.

When the reservoir 2003 is pushed into the adapter 2100, the protruding portion 2103 of the base bracket enters the insertion space 2005, and the eight positioning beads 2104 which are beneath the protruding portion 2103 fall into the grooves 2004 which are beneath the insertion space 2005. Additionally, when the positioning beads 2104 fall into the grooves 2004, they emit a sound to alert the user that the reservoir 2003 is securely positioned.

In some exemplary embodiments, the bottom of the adapter 2100 is further equipped with two sets of hooks 2105 and 2106, which are located on the right and left sides of the adapter 2100 respectively. The two sets of hooks 2105 and 2106 are configured to secure the adapter 2100 to the 3D printing device; for example, and without limiting the scope of the present invention, these hooks may couple onto a body of the curing light engine of the 3D printer. Naturally, other coupling components may be employed, such as using similar or corresponding complimentary geometries or surfaces on the adapter body that match and register with similar or corresponding complimentary geometries or surfaces on a structure of the 3D printer. For example, in some exemplary embodiments, adapter 2100 is adapted to couple directly to an LCD cartridge of an existing 3D printer for which kit 1830 may be used to retrofit the printer for multi-material printing in accordance with the present invention.

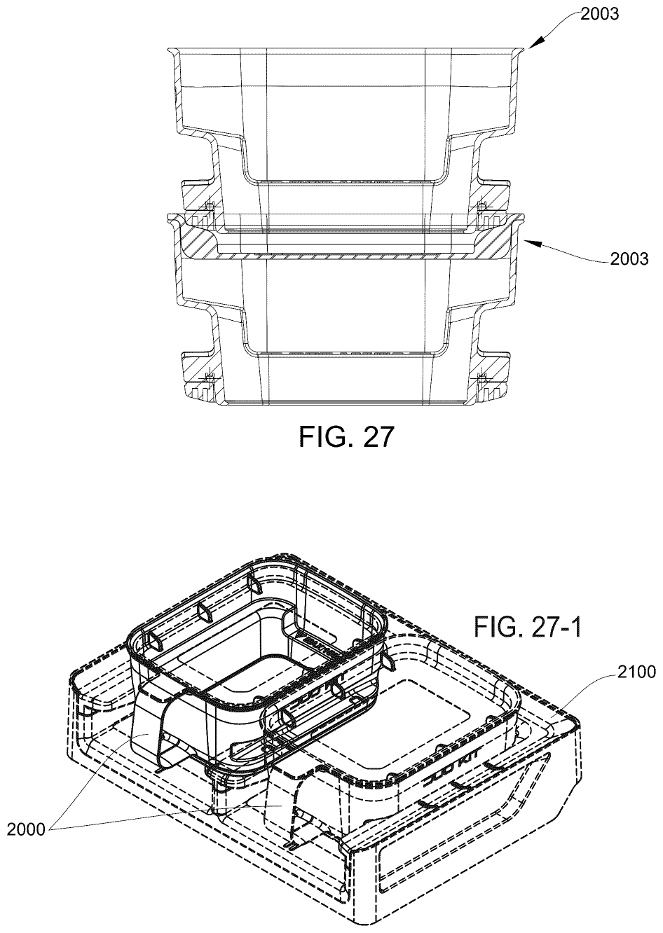

FIG. 25 illustrates a top view of one of the plurality of reservoirs, or reservoir 2003. FIG. 26 illustrates a cross-sectional view at A-A in FIG. 25. FIG. 27 illustrates a cross-sectional view of the plurality of reservoirs in a stacked state, and FIG. 27-1 illustrates reservoirs coupled to adapter 2100. As shown in FIG. 27, two or more resin tanks or reservoirs 2003 with reservoir covers 2001 may be constructed such that they can be efficiently stored. For example, and without limiting the scope of the present invention, reservoirs 2003 may be stackable for easier storage and management by a user. This may be achieved in any number of ways, including for example by implementing a suitable shape on a surface of reservoir cover 2001. As shown in this view, a concave shape may be formed on a top surface of the cover with three ribs 2008 on each side of the concave (see also FIG. 23). As shown in FIGS. 24-27, when reservoirs 2003 are stacked, the ribs 2008 are tangent to the bottom steel ring 2009 of the reservoir 2003, and the shapes of both match or register, allowing the reservoirs to be stacked securely. The reservoirs may then be decoupled, unstacked, and when in use coupled to adapter 2100 as shown in FIG. 27-1.

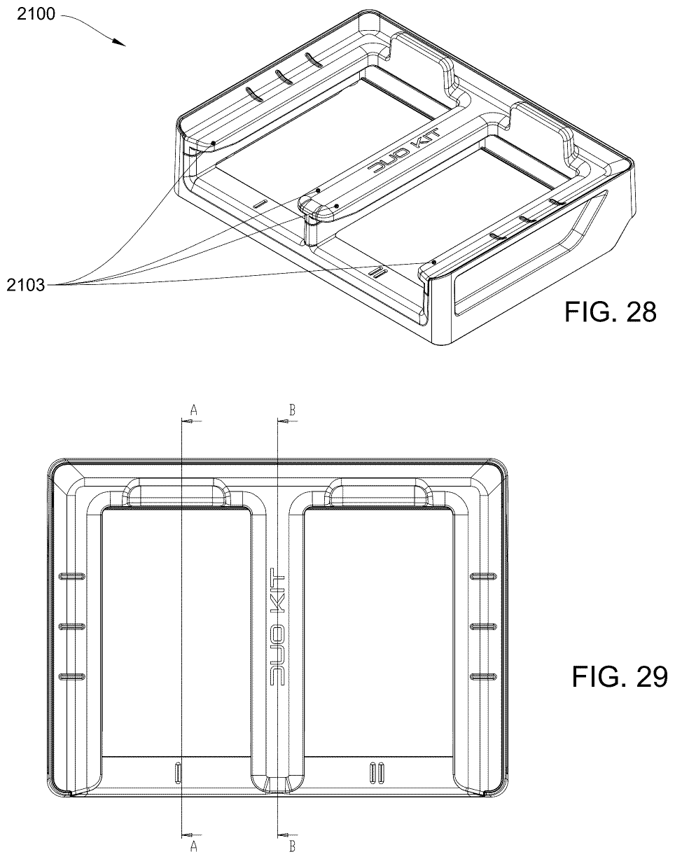

FIG. 28 illustrates an isometric side view of adapter 2100. FIG. 29 illustrates a top view of adapter 2100, and FIG. 30 illustrates a cross-sectional view at A-A in FIG. 29. In some exemplary embodiments, as shown in FIG. 22, the reservoir 2003 further includes a handle 2002, an RFID tag 2006, and a membrane 2007. The handle 2002 may be positioned on a side of the reservoir 2003, the handle 2002 may be position to be facing the user, and the handle 2002 should be configured to facilitate the user's handling of the reservoir 2003. As shown in FIG. 23, the RFID tag 2006 is adhered to a side of the reservoir 2003, in this case a posterior or rear side, and the RFID tag 2006 is configured to detect whether the reservoir 2003 is connected to the adapter 2100. Specifically, when the reservoir 2003 is pushed into the adapter 2100, the RFID tag 2006 connects with reader 2102 (see FIG. 30) which is positioned inside the rear side of the adapter 2100, the reader 2102 can recognize and read the information, which is stored in the RFID tag 2006, indicating that the reservoir 2003 is connected to the adapter 2100. Furthermore, the RFID tag 2006 is writable and can store relevant information about the reservoir 2003, such as whether photopolymer resin is present inside the reservoir 2003, the type of photopolymer resin, and the number of print cycles.

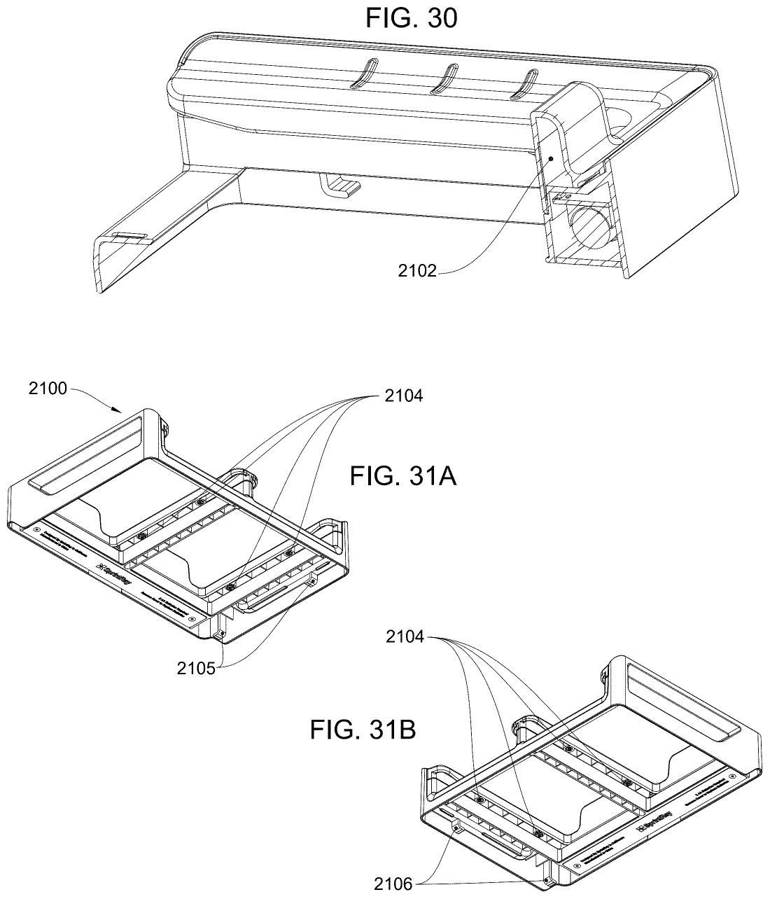

FIG. 31A-FIG. 31B illustrates posterior bottom perspective views of adapter 2100. More specifically, these views further illustrate the bottom structure of adapter 2100. Furthermore, as shown in FIG. 24, each side of reservoirs 2003 includes an insertion space 2005, which matches the protruding portion 2103 of the base bracket of the adapter 2100 as shown in FIG. 28. The protruding portion 2103 extends into the adapter's fitting area for each reservoir 2003. Along with the direction of insertion/removal of the resin tank 2003, two positioning beads 2104 are positioned beneath the protruding portion 2103, which can be seen in FIG. 31A and FIG. 31B. The positioning beads 2104 match the grooves 2004 of the resin tank 2003, thereby securing the resin tank 2003 in the adapter 2100.

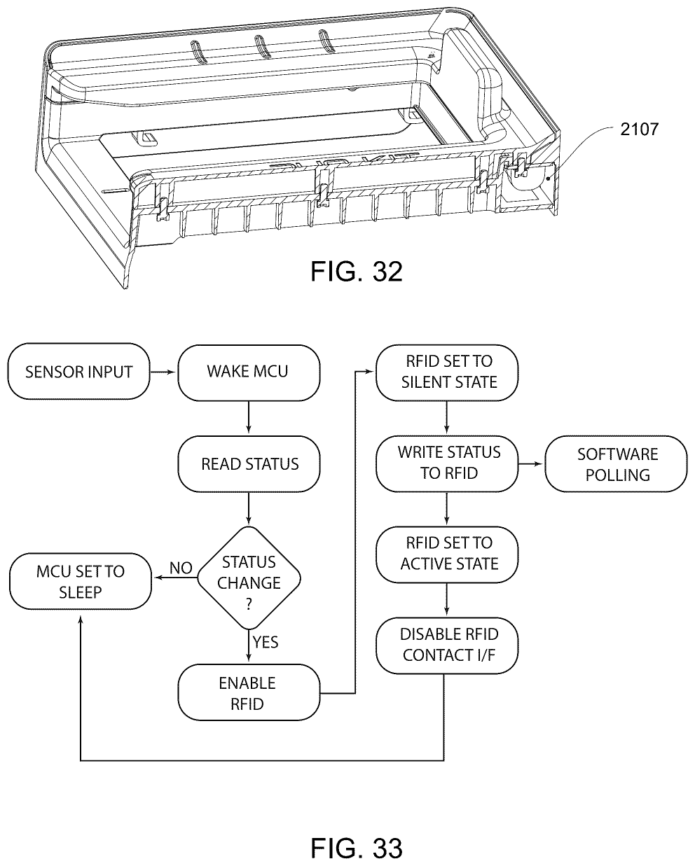

FIG. 32 illustrates a cross-sectional view at B-B in FIG. 29. In some exemplary embodiments, as shown in FIG. 32, the RFID tag 2107 is positioned inside the center of the rear side of the adapter 2100. The RFID tag 2107 is adapted to detect whether the adapter 2100 is connected to the 3D printing device. In some exemplary embodiments, when the RFID tag 2107 is connected to a reader on the 3D printing device, the reader can recognize and read the information stored in the RFID tag 2107, indicating that the 3D printing device is connected to the adapter 2100.

FIG. 33 illustrates an exemplary flow chart for an RFID reading of an adapter of a 3D printing kit in accordance with the present invention. The RFID tag 2006 is adapted to be writable and to store relevant information about the reservoir 2003 to which it corresponds. Upon activation by the Hall sensor, the MCU on the adapter 2100 transitions from sleep mode to an active state. The RFID reader 2102 on the adapter 2100 is then enabled to retrieve information from the RFID tag 2107 attached to the reservoir 2003. If the retrieved information remains unchanged, the MCU returns to sleep mode. However, if a change is detected, the MCU first sets the active RFID tag 2107 to a silent state to prevent communication conflicts. It then writes the updated information to the active RFID tag 2107 and subsequently restores it to an active state, allowing the printer software to poll the information. After completing this process, the MCU re-enters sleep mode.

The invention has the following advantages: allows for the simultaneous printing with different photopolymer resins; and significantly improves printing efficiency, as shown in the following tables, where Table 1 shows results for a traditional printer, and Table 2 shows results using a device in accordance with the present invention:

TABLE 1

| | Step | | | | | |
|---|---|---|---|---|---|---|
| Current | Setup | | Clean | Setup | | |
| System | DM | Print | setup | crown | Print | Done |
| Time | 2 min | 25 min | 4 min | 2 min | 15 min | / |

| | |
|---|---|
| Total Time | 48 min |

TABLE 2

| | Step | | |
|---|---|---|---|
| Dual System | Setup DM and Crown | Print | Done |
| Time | 3 min | 25 min | / |

| | |
|---|---|
| Total Time | 28 min |

As can be seen from Table 1 and Table 2, the use of the dual material kit can reduce the printing time by up to 42%. The present invention provides a printing device for a dual material kit, which enables the simultaneous printing with two different photopolymer resins, significantly reducing overall printing time and improving printing efficiency.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A three-dimensional (3D) printing system for retrofitting a 3D printer to print multiple 3D-printed objects, comprising:
a removable platform adapted to be used with the 3D printer, the removable platform including a plurality of build surfaces;
a plurality of sealable reservoirs adapted to register with the plurality of build surfaces of the platform, wherein each sealable reservoir is adapted to store one or more printing materials; and
an adapter configured to secure the plurality of sealable reservoirs to the 3D printer in a manner so that:
each of the plurality of sealable reservoirs are aligned with a curing light engine of the 3D printer, and
each of the plurality of sealable reservoirs registers with a corresponding build surface of the plurality of build surfaces of the platform.

2. The 3D printing system of claim 1, wherein the adapter is adapted to couple onto a body of the curing light engine of the 3D printer.

3. The 3D printing system of claim 1, wherein each sealable reservoir stores a unique printing material.

4. The 3D printing system of claim 1, wherein each build surface is adapted to independently build a 3D printed object while being positioned on the same horizontal plane as each other build surface.

5. The 3D printing system of claim 1, wherein the build surfaces are arranged parallel to one other.

6. The 3D printing system of claim 1, wherein an interior of the platform includes a temperature sensor.

7. The 3D printing system of claim 1, wherein an interior of the platform includes an overheat protection sensor.

8. The 3D printing system of claim 1, wherein an interior of the platform includes a heating element adapted to heat one or more of the build surfaces.

9. The 3D printing system of claim 1, wherein one or more of the reservoirs includes a handle.

10. The 3D printing system of claim 1, wherein the platform includes a hard anodized aluminum with a laser-etched pattern to optimize adhesion.

11. The 3D printing system of claim 1, wherein the reservoirs are stackable.

12. The 3D printing system of claim 1, wherein the reservoirs include a detection device configured to be detected by the 3D printer for detecting when the reservoir is coupled to the 3D printer.

13. The 3D printing system of claim 1, wherein the detection device includes an RFID tag.

14. The 3D printing system of claim 1, wherein the detection device may be writable and adapted to store information about the reservoirs, a printing material inside the reservoir, or a number of remaining print cycles for each reservoir.

15. The 3D printing system of claim 1, wherein each reservoir includes a membrane adapted to enhance durability when exposed to highly corrosive print materials.
